(19) United States
(12) Patent Application Publication
(10) Pub. No.: US 2024/0278351 A1
(43) Pub. Date: Aug. 22, 2024

(54) LASER MACHINING DEVICE AND NUMERICAL CONTROL DEVICE

(71) Applicant: FANUC CORPORATION, Yamanashi (JP)

(72) Inventor: Jun YAGI, Yamanashi (JP)

(73) Assignee: FANUC CORPORATION, Yamanashi (JP)

(21) Appl. No.: 18/571,099

(22) PCT Filed: Jul. 1, 2021
(86) PCT No.: PCT/JP2021/024985

§ 371 Date: Dec. 15, 2023

(51) Int. Cl. B23K 26/0622; B23K 26/36

(52) U.S. Cl. CPC B23K 26/0622; B23K 26/36

(57) ABSTRACT

A numerical control device for controlling a laser machining device that machines a workpiece by means of a pulse laser emitted from a laser machining head while moving the laser machining head and the workpiece relative to each other, said numerical control device being provided with: a speed command generation unit for generating a speed command for controlling the speed of the relative movement on the basis of a machining program; a laser command generation unit for generating a laser output command value that includes at least the frequency and duty of the pulse laser, in accordance with the speed command; a change rate calculation unit for calculating a period command for the pulse laser on the basis of the frequency, and calculating a change rate of a changed period command changed by a limitation for the performance of the laser machining device; and a speed adjustment unit for using the change rate to adjust the speed command generated by the speed command generation unit.

### TECHNICAL FIELD

The present invention relates to a numerical control device for a laser machining device.

### BACKGROUND ART

A technique of making holes with a pulsed laser at equal intervals in a workpiece has been known. For example, Patent Document 1 describes as follows from the upper left column to the lower left column on page 3: “FIG. 4(a) shows the movement speed of a workpiece (9) moved by movement means, . . . . FIG. 4 (b) shows the magnitude of output from a pulse generator, i.e., the magnitude of a frequency, and shows the magnitude of an output signal from a voltage-frequency converter (15), i.e., the magnitude of a frequency, and the magnitude changes according to the movement speed of the workpiece (9). Here, when the feeding speed of the workpiece (9) is represented by V, the frequency of the output waveform of the voltage-frequency converter (15) is represented by F, and the output of a setter (16) shown in FIG. 3, i.e., a setting pitch, is represented by P′, F=V/P′ is obtained. From this equation, P′=V/F . . . (1) is obtained. When the pitch of actually-formed holes (10) is represented by P,

a relationship of P=V/F is obtained and P=P′ is obtained from Equation (1) above, and therefore, the pitch P can be set as the output of a pitch setter (14) and the holes (10) can be made at constant pitches in the workpiece (9) even while the movement speed V of the workpiece is changing.”
In addition to hole making as described above, pulsed laser has been currently used for various types of precision machining such as semiconductor product machining and glass lens machining.
Patent Document 1: Japanese Unexamined Patent Application, Publication No. S59-42194

### DISCLOSURE OF THE INVENTION

### Problems to be Solved by the Invention

However, due to limitations on device performance, even when the frequency of a pulsed laser is changed according to a change in the relative movement speed of a laser machining head and a workpiece, if the frequency is high, the cycle of a pulsed laser output from a device cannot follow the frequency change, and a change in such a cycle is discontinuous.

FIG. 3 shows graphs for describing problems of the prior art. The horizontal axis represents the feeding speed of the laser machining head. FIG. 3 shows three graphs, and a “PULSE FREQUENCY” graph shows a change in the frequency of a pulsed laser. In order to machine the workpiece by irradiating the workpiece with a laser at a constant pitch, control of changing the pulse frequency of the laser in proportion to the feeding speed of the laser machining head is performed. A “PULSE CYCLE” graph shows a change in the cycle of a pulsed laser output from the laser machining device. A “RUNNING DISTANCE PER PULSE CYCLE” graph shows a change in a distance by which the laser machining head runs in each cycle of the pulsed laser. Hereinafter, the distance by which the laser machining head runs in each cycle of the pulsed laser will also be referred to as a “pulse interval”.

The pulse cycle is the inverse of the pulse frequency. Thus, in a case where the pulse frequency linearly changes in proportion to the feeding speed of the laser machining head, the pulse cycle is supposed to continuously change along a smooth hyperbolic curve. However, the laser machining device has various limitations such as a limitation on a resolution for a pulse cycle command, and cannot follow the pulse cycle command calculated based on the pulse frequency. As a result, as shown in FIG. 3, the cycle of the pulsed laser output from the laser machining device discontinuously changes, and the graph thereof shows bumps (step-like bumps). The higher the pulse frequency, the more noticeable the bumps appear in the pulse cycle graph.

Due to influence of these bumps, the “RUNNING DISTANCE PER PULSE CYCLE” graph also shows bumps. That is, the pulse interval is not constant, and for this reason, the intervals of spots to be irradiated with the pulsed laser are not constant. Thus, the accuracy of laser machining is lowered, leading to, e.g., a problem that a defect is caused at a machined portion.

### Means for Solving the Problems

A numerical control device according to one embodiment of the present disclosure is a numerical control device for controlling a laser machining device that machines a workpiece with a pulsed laser emitted from a laser machining head while moving the laser machining head and the workpiece relative to each other, the numerical control device including a speed command generation unit that generates a speed command for controlling the speed of relative movement based on a machining program, a laser command generation unit that generates, according to the speed command, a laser output command value including at least the frequency and duty ratio of the pulsed laser, a change rate computation unit that calculates a cycle command for the pulsed laser based on the frequency and calculates a change rate for a changed cycle command changed from the cycle command due to a limitation on performance of the laser machining device, and a speed adjustment unit that adjusts, using the change rate, the speed command generated by the speed command generation unit.

### Effects of the Invention

According to the above-described embodiment, the intervals of pulsed laser irradiation spots of a machining surface can be constant even when a change in a pulse cycle is discontinuous.

### BRIEF DESCRIPTION OF THE DRAWINGS

FIG. 1 shows a block diagram of the configuration of a numerical control device in one embodiment of the present invention;

FIG. 2 shows a schematic view for describing advantageous effects of the embodiment of the present invention; and

FIG. 3 shows graphs for describing problems of the prior art.

### PREFERRED MODE FOR CARRYING OUT THE INVENTION

Hereinafter, an embodiment of the present invention will be described with reference to the drawings.

### First Embodiment

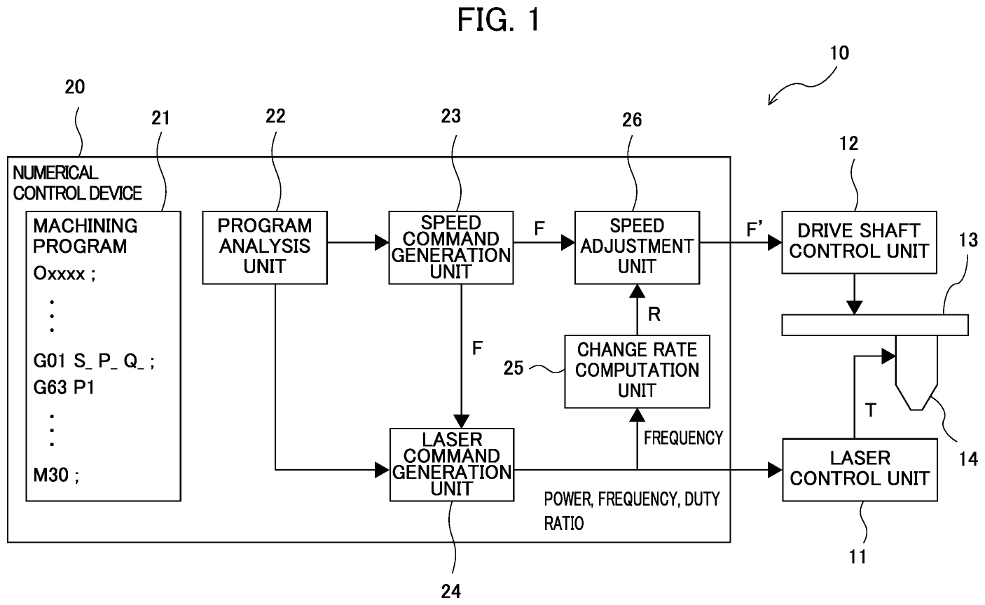

FIG. 1 shows a block diagram of the configuration of a numerical control device in one embodiment of the present invention. The numerical control device of this embodiment is a numerical control device 20 that controls a laser machining device 10 that machines a workpiece with a pulsed laser emitted from a laser machining head 14. The laser machining device 10 has a laser control unit 11 that controls the pulsed laser emitted from the laser machining head 14 and a drive shaft control unit 12 that controls a drive shaft 13 that moves the laser machining head 14 and the workpiece relative to each other. For the sake of a simple description of the present embodiment, it is assumed that in the present embodiment, the workpiece is fixed and the drive shaft 13 controlled by the drive shaft control unit 12 moves only the laser machining head 14. That is, the feeding speed (movement speed) of the laser machining head 14 is the relative movement speed of the laser machining head 14 and the workpiece.

As shown in FIG. 1, the numerical control device 20 includes a program analysis unit 22, a speed command generation unit 23, a laser command generation unit 24, a change rate computation unit 25, and a speed adjustment unit 26. The program analysis unit 22 analyzes a machining program 21 to send analysis information to a relevant unit. For example, in a case where the analysis information is information on the feeding speed of the laser machining head 14, the information is sent to the speed command generation unit 23. In a case where the analysis information is information on the frequency of the pulsed laser, the information is sent to the laser command generation unit 24.

The speed command generation unit 23 generates, based on the machining program 21 analyzed by the program analysis unit 22, a speed command F for controlling the feeding speed of the laser machining head 14. The speed command generation unit 23 sends the generated speed command F to the laser command generation unit 24 and the speed adjustment unit 26. The laser command generation unit 24 can control the power of the pulsed laser. The laser command generation unit 24 generates, according to the speed command F, a laser output command value including at least the frequency and duty ratio of the pulsed laser. For example, the laser command generation unit 24 generates a frequency command value f for the pulsed laser in proportion to the speed command F according to Mathematical Equation 1 below, and sends the frequency command value f to the change rate computation unit 25 and the laser control unit 11.

$$f = \frac{F}{D} \qquad [ Mathematical Equation 1 ]$$

In Mathematical Equation 1, D represents a constant and a distance which is targeted by the laser machining device 10 and by which the laser machining head 14 runs in each cycle of the pulsed laser. Hereinafter, the constant D will also be referred to as a “target pulse interval”.

Based on the frequency command value f from the laser command generation unit 24, the laser control unit 11 calculates a cycle command T (=1/f) for the pulsed laser, and controls the pulsed laser emitted from the laser machining head 14.

Based on the frequency command value f from the laser command generation unit 24, the change rate computation unit 25 calculates a cycle command T (=1/f) for the pulsed laser. Note that the change rate computation unit 25 calculates a cycle change rate R for a changed cycle command T′ changed from the cycle command T due to a limitation on performance of the laser machining device 10, and sends the cycle change rate R to the speed adjustment unit 26. The cycle change rate R is calculated according to Mathematical Equation 2 below.

$$R ( n + a ) = \frac{T ( n )}{{T}^{′} ( n + a )} \qquad [ Mathematical Equation 2 ]$$

Note that n is an arbitrary natural number. T(n) represents a cycle command immediately before the start of a change in the cycle command due to the limitation on the performance of the laser machining device 10 (deviation from the cycle command (1/f) calculated based on the frequency command value f). T′ (n+a) is a changed cycle command T′ at each point of time while the cycle command is changing.
a is a natural number such as “1, 2, 3, . . . ”. In a case where the change rate (acceleration) of the speed command F over time changes, T(n) at a new acceleration needs to be used.

The speed adjustment unit 26 adjusts, using the cycle change rate R, the speed command F generated by the speed command generation unit 23 to generate an adjusted speed command F′, and sends the adjusted speed command F′ to the drive shaft control unit 12. The speed adjustment unit 26 adjusts the speed command based on Mathematical Equation 3 below.

$${F}^{′} ( n + a ) = F ( n ) \times R ( n + a ) \qquad [ Mathematical Equation 3 ]$$

Note that F(n) represents a speed command F at n corresponding to T(n).

The changed cycle command T′ is calculated by simulation calculation by the change rate computation unit 25 based on a model for reflecting the limitation on the performance of the laser machining device 10 on the cycle command T. For example, the change rate computation unit 25 calculates the changed cycle command T′ based on a model for reflecting a limitation on the resolution of the laser machining device 10 on the cycle command T. Hereinafter, the limitation on the resolution of the laser machining device 10 and a method for calculating the changed cycle command T′ reflecting such a limitation will be described.

For example, it is assumed that the resolution S of the laser machining device 10 for the cycle command T is 0.5 μs, the cycle command T(n) calculated for the pulsed laser at n based on the frequency command value f by the change rate computation unit 25 is 0.5 μs, the cycle command T(n+1) at (n+1) is 0.6 μs, the cycle command T(n+2) at (n+2) is 0.7 μs, the cycle command T(n+3) at (n+3) is 0.8 μs, the cycle command T(n+4) at (n+4) is 0.9 μs, the cycle command T(n+5) at (n+5) is 1.0 μs, and the cycle command T(n+6) at (n+6) is 1.1 μs. Note that it is assumed that the change rate (acceleration) of the speed command F over time is constant. The same also applies to the cycle command T calculated based on the frequency command value f by the laser control unit 11.

Among the calculated cycle commands T, the cycle command T(n)=0.5 μs at n and the cycle command T(n+5)=1.0 μs at (n+5) are the integral multiples of the resolution S (0.5 μs). Thus, the laser machining device 10 can follow a change in these cycle commands, and can control the pulsed laser as in the cycle commands. However, the values (0.6 to 0.9 and 1.1 μs) of the cycle commands at the other points of time are not the integral multiples of the resolution S (0.5 μs). Thus, the laser machining device 10 cannot follow a change in these cycle commands. As a result, the laser machining device 10 controls, from (n+1) to (n+4), the pulsed laser according to the cycle command (0.5 μs) at n which reaches the integral multiple of the resolution S before (n+1) to (n+4), and at (n+6), controls the pulsed laser according to the cycle command (1.0 μs) at (n+5) which reaches the integral multiple of the resolution S before (n+6).

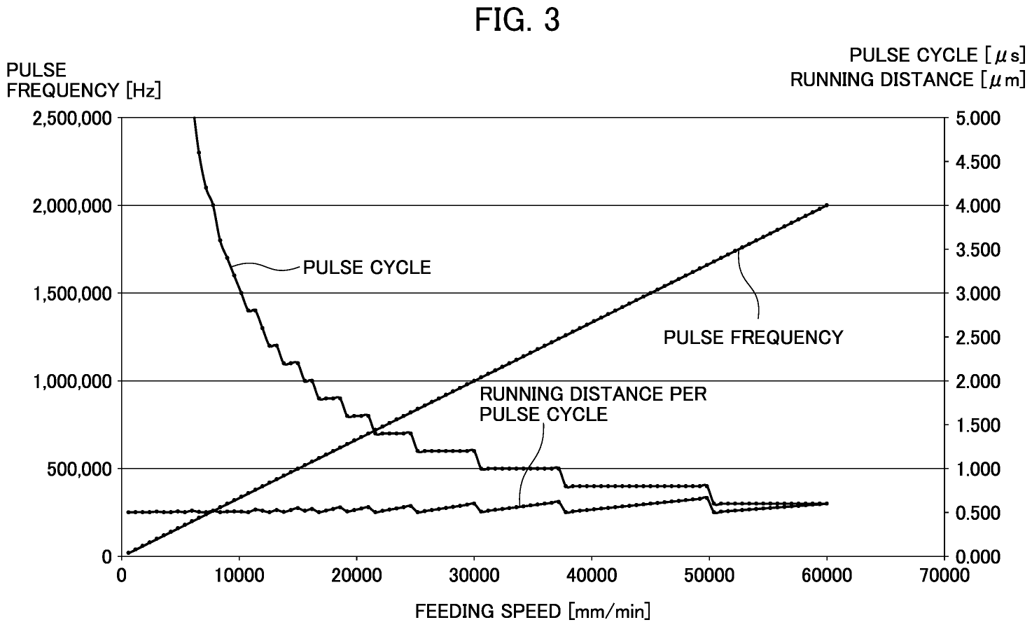

For this reason, the cycle command for controlling the pulsed laser actually changes in a stepwise manner as in a “PULSE CYCLE” graph of FIG. 3. As a result, even when the frequency command value f is generated based on Mathematical Equation 1 and the pulsed laser is controlled based thereon, the pulse interval cannot be constant as in the target pulse interval D.

In the present embodiment, the changed cycle command T′ reflecting the limitation on the resolution of the laser machining device 10 and generated approximate to the actual cycle command for controlling the pulsed laser is calculated according to Mathematical Equation 4 below.

$${T}^{′} = floor ( T / S ) \times S \qquad [ Mathematical Equation 4 ]$$

In Mathematical Equation 4, floor is a function used for, e.g., a C language, and is also a function for rounding down to the nearest decimal. Note that as described above, S represents the resolution of the laser machining device 10 for the cycle command T and T is the cycle command calculated based on the frequency command value f.

For example, in the case of the cycle command T(n+2)=0.7 μs at (n+2) and S=0.5 μs in the above-described example, when the changed cycle command T′ is calculated according to Mathematical Equation 4, the changed cycle command T′ is 0.5 μs as in Mathematical Equation 5 below.

$${T}^{′} = floor ( 0.7 / 0.5 ) \times 0.5 = floor ( 1.4 ) \times 0.5 = 1. \times 0.5 = 0.5 [ μs ] \qquad [ Mathematical Equation 5 ]$$

When the changed cycle commands T′ at the other points of time in the above-described example are calculated according to Mathematical Equation 4, all the changed cycle commands T′ from (n+1) to (n+4) are 0.5 μs, and the changed cycle commands T′ at (n+5) and (n+6) are 1.0 μs.

These results are the same as the pulsed laser being controlled using the cycle command at the point of time when the cycle command previously reaches the integral multiple of the resolution S of the laser machining device 10 in a case where the value of the cycle command T is not the integral multiple of the resolution S. That is, influence of the limitation on the resolution of the laser machining device 10 on the cycle command can be reflected using the model represented by Mathematical Equation 4.

Thus, in the present embodiment, the change rate computation unit 25 calculates the changed cycle command T′ according to Mathematical Equation 4, calculates the cycle change rate R according to Mathematical Equation 2, and sends the cycle change rate R to the speed adjustment unit 26. The speed adjustment unit 26 adjusts, using the cycle change rate R, the speed command F according to Mathematical Equation 3, thereby generating the adjusted speed command F′. The drive shaft control unit 12 controls the feeding speed of the laser machining head 14 based on the adjusted speed command F′.

In the above-described example, the cycle command T(n)=0.5 μs is equivalent to “T(n)” in Mathematical Equation 2, i.e., the cycle command immediately before the start of the cycle command change. Note that (n+1) to (n+6) are equivalent to “(n+a)” in Mathematical Equation 2, and at these points of time, the cycle command deviates from the calculated cycle command (1/f) and changes to the changed cycle command T′ (n+a). Among these points of time, at (n+5), the changed cycle command T′ (n+5) is equal to the cycle command T(n+5), i.e., 1.0 μs. That is, at (n+5), the actual cycle command for controlling the pulsed laser is coincident with the cycle command (1/f) calculated based on the frequency command value f, and does not deviate from the calculated cycle command (1/f). However, in calculation for control according to Mathematical Equations 2 and 3, it is convenient to take the cycle command at such a point of time as the changed cycle command T′, and results accurately reflecting the situation are obtained even when the changed cycle command T′ at such a point of time is calculated according to Mathematical Equation 4. Thus, in the present embodiment, the cycle command coincident with the calculated cycle command (1/f) while the cycle command is changing is also taken as the changed cycle command T′.

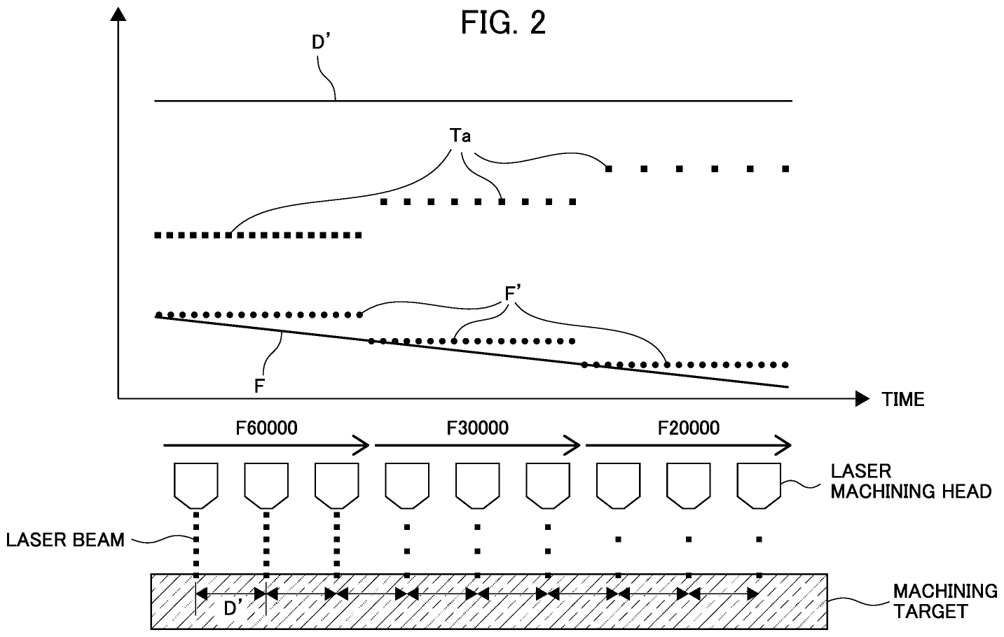

FIG. 2 shows a schematic view for describing advantageous effects of the present embodiment. An upper portion of FIG. 2 shows graphs for schematically describing a change in each parameter over time. A lower portion of FIG. 2 shows a schematic view of the distance by which the laser machining head runs in each cycle of the pulsed laser, i.e., an adjusted pulse interval D′, under each adjusted speed command F′. FIG. 2 shows an example where the speed command F for controlling the feeding speed of the laser machining head linearly lowers.

As shown in FIG. 2, a change in an actual pulsed laser cycle measurement value Ta over time is discontinuous, and the graph thereof shows bumps. The graph of a change in the adjusted speed command F′ calculated using the changed cycle command T′ according to Mathematical Equations 2 and 3 also shows bumps corresponding to those of the actual cycle measurement value Ta. As shown on the uppermost side of FIG. 2, when the feeding speed of the laser machining head 14 is controlled using the adjusted speed command F′, the adjusted pulse interval D′ is maintained at a constant value even while the feeding speed is changing. That is, the distance by which the laser machining head runs in each cycle of the pulsed laser is controlled constant.

This result is also confirmed by calculation according to Mathematical Equation 6 below.

$${D}^{′} = {F}^{′} \times Ta \qquad [ Mathematical Equation 6 ]$$

For example, it is assumed that in FIG. 2, the actual cycle measurement value Ta of the left point sequence is 0.5 μs, the value of the center point sequence is 1.0 μs, and the value of the right point sequence is 1.5 μs. Note that as indicated by “F60000”, “F30000”, and “F20000”, the value of the adjusted speed command F′ of the left point sequence is 60000 mm/min, the value of the center point sequence is 30000 mm/min, and the value of the right point sequence is 20000 mm/min. Since the corresponding actual cycle measurement value Ta of the left point sequence is 0.5 μs and the corresponding adjusted speed command F′ of the left point sequence is 60000 mm/min, D′=0.5 μm is obtained when Mathematical Equation 6 is solved with these values substituted therein. By similar calculation for the center point sequence and the right point sequence, a result of D′=0.5 μm is similarly obtained.

A lower portion of FIG. 2 shows a schematic view of such an image that the distance by which the laser machining head runs in each cycle of the pulsed laser can be controlled constant even under different feeding speeds. In FIG. 2, an interval between the point sequences of the actual cycle measurement value Ta and an interval between point sequences indicating laser beams are images of the corresponding cycles of the pulsed laser.

The numerical control device according to the present embodiment calculates the changed cycle command T′ by simulation calculation by the change rate computation unit 25 based on the model for reflecting the limitation on the performance of the laser machining device 10 on the cycle command T, calculates the cycle change rate R for the changed cycle command T′ from the cycle command T, and adjusts the speed command F based on the cycle change rate R. With this configuration, the distance by which the laser machining head 14 runs in each cycle of the pulsed laser can be controlled constant even under different feeding speeds, and the intervals of pulsed laser irradiation spots of a machining surface can be controlled constant.

### Second Embodiment

The present embodiment is a modification of the first embodiment. A laser machining device and a numerical control device according to the present embodiment may have the configurations of the laser machining device 10 and the numerical control device 20 as shown in FIG. 1. Thus, description of components having the same functions as those of the first embodiment will be omitted.

A main difference between the present embodiment and the first embodiment is that as the changed cycle command T′ used for Mathematical Equation 2 for calculating the cycle change rate R, the actual pulsed laser cycle measurement value Ta actually measured in test operation of the laser machining device 10 is used. That is, the change rate computation unit 25 does not calculate the changed cycle command T′ based on the model, but calculates the cycle change rate R using the stored actual cycle measurement value Ta and sends the cycle change rate R to the speed adjustment unit 26. The speed adjustment unit 26 adjusts, using such a cycle change rate, the speed command based on Mathematical Equation 3. In a case where the actual cycle measurement value Ta has, e.g., a measurement error, processing of reducing, e.g., the measurement error may be performed, and the cycle change rate R may be calculated using the value calculated based on the actual cycle measurement value Ta.

Since the actual cycle measurement value Ta is a value under various limitations on the performance of the laser machining device 10, the speed command F is adjusted based on the cycle change rate R calculated using the actual cycle measurement value Ta so that the adjusted pulse interval D′ can be more accurately controlled constant.

Each component of the numerical control device 20 may include a program that describes operation thereof and a CPU that executes the program. The numerical control device 20 may include a computer, and each component of the numerical control device 20 may be implemented in such a manner that a CPU of the computer executes a program describing the function of each component.

In the above-described embodiments, each of the change rate computation unit 25 and the laser control unit 11 calculates the cycle command T based on the frequency command value f. However, the laser command generation unit 24 may calculate the cycle command T, and may send the cycle command T to the change rate computation unit 25 and the laser control unit 11.

The present invention has been described above with reference to the embodiments, but the technical scope of the present invention is not limited to the scopes of the above-described embodiments. It is obvious to those skilled in the art that various changes or modifications can be made to the above-described embodiments. From description of the claims, it is obvious that these changed or modified embodiments are also included in the technical scope of the present invention. For example, the above-described embodiments have been described in detail for the sake of a simple description of the present invention, and the present invention is not limited to those including all the components described above. Note that some components of each embodiment may be replaced with other components or may be omitted.

### EXPLANATION OF REFERENCE NUMERALS

10 Laser Machining Device
11 Laser Control Unit
12 Drive Shaft Control Unit
13 Drive Shaft
14 Laser Machining Head
20 Numerical Control Device
21 Machining Program
22 Program Analysis Unit
23 Speed Command Generation Unit
24 Laser Command Generation Unit
25 Change Rate Computation Unit
26 Speed Adjustment Unit
D Target Pulse Interval
D′ Adjusted Pulse Interval
f Frequency Command Value
F Speed Command
F′ Adjusted Speed Command
R Cycle Change Rate
S Resolution for Cycle Command
T Cycle Command
T′ Changed Cycle Command
Ta Actual Cycle Measurement Value

1. A numerical control device for controlling a laser machining device that machines a workpiece with a pulsed laser emitted from a laser machining head while moving the laser machining head and the workpiece relative to each other, comprising:
a speed command generation unit that generates a speed command for controlling a speed of relative movement based on a machining program;
a laser command generation unit that generates, according to the speed command, a laser output command value including at least frequency and duty ratio of the pulsed laser;
a change rate computation unit that calculates a cycle command for the pulsed laser based on the frequency and calculates a change rate for a changed cycle command changed from the cycle command due to a limitation on performance of the laser machining device; and
a speed adjustment unit that adjusts, using the change rate, the speed command generated by the speed command generation unit.

2. The numerical control device according to claim 1, wherein
the changed cycle command is calculated by simulation calculation by the change rate computation unit based on a model for reflecting the limitation on the performance of the laser machining device on the cycle command.

3. The numerical control device according to claim 2, wherein
the limitation on the performance of the laser machining device is a limitation of a resolution of the laser machining device for the cycle command.

4. The numerical control device according to claim 1, wherein
as the changed cycle command, an actual pulsed laser cycle measurement value actually measured in test operation of the laser machining device or a value calculated based on the actual pulsed laser cycle measurement value is used.
